(19) United States
(12) Patent Application Publication
(10) Pub. No.: US 2026/0070329 A1
(43) Pub. Date: Mar. 12, 2026

(54) LIQUID EJECTION APPARATUS AND CONTROL METHOD

(71) Applicant: CANON KABUSHIKI KAISHA, Tokyo (JP)

(72) Inventors: FUMI TANAKA, Kanagawa (JP); SHUZO IWANAGA, Kanagawa (JP); KEIJI TOMIZAWA, Kanagawa (JP); KOICHI ISHIDA, Tokyo (JP); YUZURU ISHIDA, Kanagawa (JP); YUJI NUKUI, Kanagawa (JP); YUGO YAMAMOTO, Kanagawa (JP); KOJI TAKASE, Kanagawa (JP)

(21) Appl. No.: 19/319,032

(22) Filed: Sep. 4, 2025

(30) Foreign Application Priority Data
Sep. 10, 2024 (JP) 2024-156564
Jul. 4, 2025 (JP) 2025-113920

(51) Int. Cl. B41J 2/045; B41J 2/14; B41J 2/165

(52) U.S. Cl. CPC B41J 2/04513; B41J 2/0458; B41J 2/14072; B41J 2/14112; B41J 2/16526

(57) ABSTRACT

Provides a technique that can suppress occurrence of the image unevenness and the like due to a burnt ink on a heater surface. To this end, between aging processing and printing processing, preprocessing is performed with a potential difference between a potential difference during aging processing and a potential difference during printing processing.

### BACKGROUND

### Field of the Technology

The present disclosure relates to a liquid ejection apparatus and a control method.

### Description of the Related Art

There is a method for a printing apparatus that ejects a liquid such as an ink from a liquid ejection head as a method of generating energy to eject the liquid, in which a heat generation resistor (hereinafter, also referred to as a “heater”) heats the ink to generate a bubble and ejects the ink. In a case of the above-described method of ejecting the ink by heating by the heater, in some cases, the ink is burnt on a surface of the heater with the heater heating the ink, and the ejection speed of the ink is changed.

Usually, the ink used in the printing apparatus as described above is an ink including a dye-based or a pigment-based colorant, and the colorant may be insoluble or poorly-soluble in water. The insoluble or poorly-soluble colorant is considered as one of the causes of the burning.

In a case where the ink that is likely to be burnt as described above is ejected while there is almost no kogation on the heater surface, kogation is produced on the heater surface having no kogation. It has been known that the heat conduction to the ink is changed accordingly, and the ejection characteristics are changed (the ejection speed is decreased).

Japanese Patent Laid-Open No. 2014-131867 proposes that preliminary ink ejection processing (hereinafter, also referred to as aging) that does not contribute to printing on a paper surface is performed in advance before the printing on the paper surface. Kogation is produced to some extent on an electrode surface by the aging to obtain uniform kogation and the stabilized electrode surface, and therefore the change in the ejection characteristics is suppressed.

Japanese Patent Laid-Open No. 2019-38127 proposes a fluid ejection apparatus including first and second electrodes arranged to generate an electric field in a liquid chamber of a liquid ejection head. Potentials of the first and second electrodes are controlled to generate the electric field in the liquid chamber, and charged particles that cause kogation are moved away from the heater surface. Therefore, it is possible to suppress the production of kogation on a substrate for the liquid ejection head during ejection, and it is possible to improve the durability of the substrate for the liquid ejection head.

It is possible to perform the aging processing disclosed in Japanese Patent Laid-Open No. 2014-131867 by controlling the potentials of the first electrode and the second electrode as disclosed in Japanese Patent Laid-Open No. 2019-38127. In this case, it is possible to efficiently perform the aging in a short time by making kogation likely to be produced during the aging, which is caused by controlling a potential difference between the first electrode and the second electrode during the aging to be smaller than a potential difference between the first electrode and the second electrode during the printing.

However, in a case where the potential differences are different between during the aging and the printing, the adhesion of the kogation is changed due to the change in the potential differences; for this reason, the kogation adhered during the aging is removed during the printing in some cases, and there is a possibility that the ejection characteristics are changed, and the image unevenness and the like occur.

### SUMMARY

Therefore, the present disclosure provides a technique that can suppress occurrence of the image unevenness and the like due to a burnt ink on a heater surface.

Therefore, liquid ejection apparatus of the present disclosure includes: an ejection unit mountable therein, including a heat generation resistor configured to generate energy to eject a liquid by generating heat by applying power, a first electrode provided to a protection unit configured to cover and protect the heat generation resistor, and a second electrode conductible with the first electrode via the liquid; and a control unit configured to control a potential difference between the first electrode and the second electrode to a predetermined value by changing at least either one of potentials of the first electrode and the second electrode and control the mounted ejection unit, in which the control unit executes aging processing to accumulate kogation on the first electrode by generating a first potential difference between the first electrode and the second electrode and performing ejection that does not contribute to printing on a printing medium from the ejection unit, preprocessing to perform ejection that does not contribute to the printing on the printing medium from the ejection unit by generating a second potential difference, which is different from the first potential difference, after the aging processing, and printing processing to eject the liquid from the ejection unit to the printing medium and perform printing by generating a third potential difference, which is different from the first potential difference and the second potential difference, between the first electrode and the second electrode after the preprocessing.

According to the present disclosure, it is possible to provide a technique that can suppress occurrence of the image unevenness and the like.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration of a liquid ejection apparatus.

FIG. 2 is a block diagram illustrating a configuration of a printing apparatus.

FIG. 3 is a schematic view illustrating a first circulation route applied to the printing apparatus.

FIG. 4 is a schematic view illustrating a second circulation route applied to the printing apparatus.

FIG. 5 is a schematic view illustrating a third circulation route different from the first circulation route and the second circulation route.

FIG. 6A is a perspective view of a liquid ejection head.

FIG. 6B is a perspective view of the liquid ejection head.

FIG. 7 is an exploded perspective view of each component or unit forming the liquid ejection head.

FIG. 8A is a diagram describing a detailed configuration of a channel member.

FIG. 8B is a diagram describing a detailed configuration of the channel member.

FIG. 8C is a diagram describing a detailed configuration of the channel member.

FIG. 8D is a diagram describing a detailed configuration of the channel member.

FIG. 9 is a diagram describing a channel structure formed inside the channel member.

FIG. 10 is a diagram describing a channel structure formed inside the channel member.

FIG. 11A is a diagram illustrating an ejection module.

FIG. 11B is a diagram illustrating the ejection module.

FIG. 12A is a diagram illustrating a printing element substrate.

FIG. 12B is a diagram illustrating the printing element substrate.

FIG. 12C is a diagram illustrating the printing element substrate.

FIG. 13 is a perspective view illustrating a cross section of the printing element substrate and a cover plate.

FIG. 14 is a plan view illustrating a partially enlarged adjacent portion of the printing element substrate.

FIG. 15A is a diagram illustrating a heat acting portion in the printing element substrate.

FIG. 15B is a diagram illustrating the heat acting portion in the printing element substrate.

FIG. 16A is a diagram illustrating electric field control in a pressure chamber.

FIG. 16B is a diagram illustrating the electric field control in the pressure chamber.

FIG. 16C is a diagram illustrating the electric field control in the pressure chamber.

FIG. 16D is a diagram illustrating the electric field control in the pressure chamber.

FIG. 17A is a diagram illustrating a change in the ejection speed in a case where aging is executed.

FIG. 17B is a diagram illustrating a change in the ejection speed in a case where the aging is executed.

FIG. 17C is a diagram illustrating a change in the ejection speed in a case where the aging is executed.

FIG. 18 is a graph illustrating a relationship between a kogation amount on an electrode surface and a potential difference.

FIG. 19 is a flowchart illustrating printing processing.

FIG. 20 is a graph illustrating a relationship between the kogation amount on the electrode surface and the potential difference.

FIG. 21 is a graph illustrating a relationship between the kogation amount on the electrode surface and the potential difference.

FIG. 22 is a diagram illustrating a change in the ejection speed in a case where the aging is executed.

### DESCRIPTION OF THE EMBODIMENTS

### First Embodiment

A first embodiment of the present disclosure is described below with reference to the drawings.

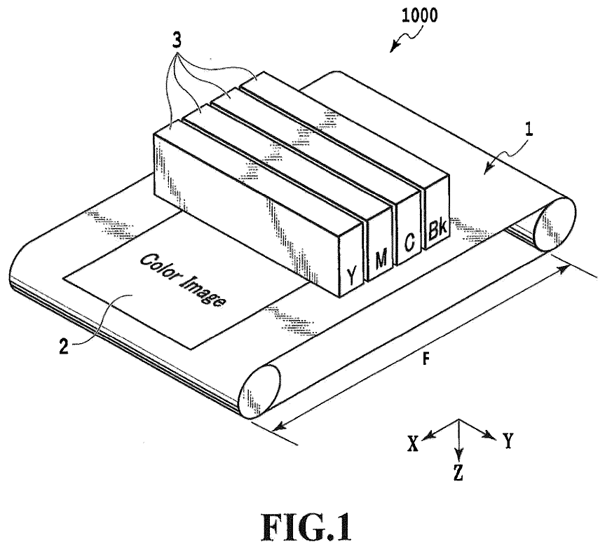

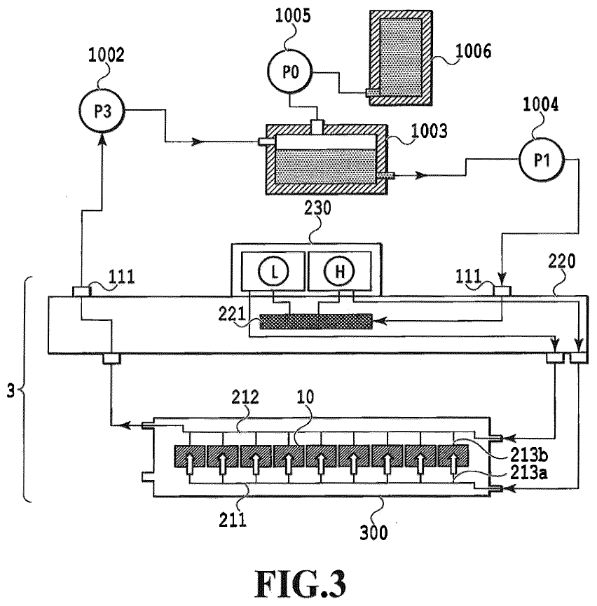

FIG. 1 is a diagram illustrating a schematic configuration of a liquid ejection apparatus (hereinafter, also referred to as a printing apparatus) 1000 in the present embodiment. The printing apparatus 1000 is a line type printing apparatus that includes a conveyance unit 1 that conveys a printing medium 2 and a line type liquid ejection head 3 arranged substantially orthogonal to a conveyance direction of the printing medium and that performs continuous printing in single pass while conveying multiple printing media 2 continuously or intermittently. The printing medium 2 is not limited to cut paper and may be continuous roll paper. The liquid ejection head 3 can perform full-color printing by inks of CMYK (cyan, magenta, yellow, and black) as liquids. The liquid ejection head 3 may be a single liquid ejection head corresponding to one color or may. be a single liquid ejection head corresponding to multiple colors. The liquid ejection head 3 ejects the liquid by applying power to the printing element to generate heat. The liquid ejection head 3 is mounted in the printing apparatus 1000 so as to be replaceable. In the liquid ejection head 3, as described later, a liquid supply unit forming a supply path to supply the ink to the liquid ejection head, an ink cartridge 1006 as a main tank, and a buffer tank 1003 are connected to each other fluidically (see FIG. 3). Additionally, an electric control unit that transmits power and an ejection control signal to the liquid ejection head 3 is electrically connected to the liquid ejection head 3. A liquid route and an electric signal route in the liquid ejection head 3 are described later. The printing apparatus 1000 circulates the ink via the liquid ejection head 3.

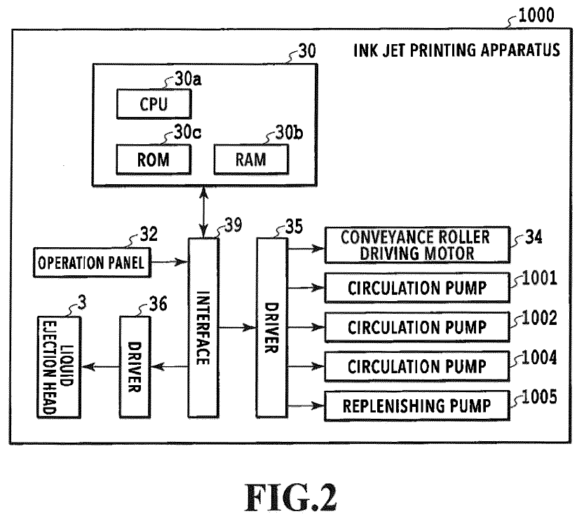

FIG. 2 is a block diagram illustrating a configuration of the printing apparatus 1000. The printing apparatus 1000 includes a control unit 30 that includes a CPU 30a such as a microprocessor and a RAM 30b that is used as a working area of the CPU 30a and saves various data such as printing data and a registration adjustment value, for example. The control unit 30 includes a ROM 30c that stores a control program of the CPU 30a and various data. In addition, the printing apparatus 1000 includes an interface 39, an operation panel 32, and drivers 35 and 36. The driver 35 controls driving of a conveyance roller driving motor 34, circulation pumps 1001, 1002, and 1004 of an ink supply channel, and a replenishing pump 1005, and a driver 36 drives the liquid ejection head 3.

The printing data received by the printing apparatus 1000 is stored in the RAM 30b of the control unit 30. According to the printing data stored in the RAM 30b, the control unit 30 outputs ON and OFF signals to drive the motor 34 to the driver 35 and outputs an ejection signal and the like to the driver 36, respectively, to form an image on the printing medium. Additionally, according to a control sequence described later, the control unit 30 outputs the signal to drive the circulation pump 1002 to the driver 35 and controls the circulation pump 1002.

FIG. 3 is a schematic view illustrating a first circulation route as a mode of a circulation route applied to the printing apparatus according to the present embodiment. As illustrated in FIG. 3, the liquid ejection head 3 is connected to two first circulation pumps 1001 (a high pressure side) and 1002 (a low pressure side), the buffer tank 1003, and the like fluidically.

The printing apparatus 1000 in which the ink cartridge 1006 storing the ink can be mounted includes the buffer tank 1003 as a sub tank connected with the ink cartridge 1006. The buffer tank 1003 includes an atmosphere communication port (not illustrated) that allows the inside of the tank to communicate with the outside and can discharge air bubbles in the ink to the outside. The buffer tank 1003 is also connected with the replenishing pump 1005. In a case where the ink is consumed by the liquid ejection head 3, the replenishing pump 1005 transfers the ink by the consumed amount from the ink cartridge 1006 to the buffer tank 1003. For example, the ink is consumed by the liquid ejection head 3 in a case where the ink is ejected (discharged) from an ejection port of the liquid ejection head such as printing and suction recovery performed by ejecting the ink.

The first circulation pump 1002 plays a role of drawing out the liquid from a liquid connection unit 111 of the liquid ejection head 3 and flowing the liquid to the buffer tank 1003. As the first circulation pump, an inner volume type pump having a quantitative liquid transfer capability is preferable. Specifically, a tube pump, a gear pump, a diaphragm pump, a syringe pump, and the like are included, and it is also possible to use a mode in which a constant flow rate is secured by arranging a general constant flow valve and a relief valve at a pump outlet, for example. While the liquid ejection head 3 is driven, the first circulation pump 1002 flows a certain amount of the ink in a common collection channel 212. It is preferable to set the flow rate to be equal to or greater than a flow rate that achieves a temperature difference between the printing element substrates 10 in the liquid ejection head 3 that does not affect the printing image quality. However, in a case where an excessively great flow rate is set, an effect of a pressure loss in a channel in a liquid ejection unit 300 excessively increases a negative pressure difference between the printing element substrates 10, and thus the density unevenness of the image occurs. Therefore, it is preferable to set the flow rate while considering the temperature difference and the negative pressure difference between the printing element substrates 10.

A negative pressure control unit 230 is provided in the middle of a route connecting a second circulation pump 1004 and the liquid ejection unit 300. Therefore, the negative pressure control unit 230 has a function to operate so as to maintain a pressure on a downstream side (that is a liquid ejection unit 300 side) of the negative pressure control unit 230 to a constant pressure set in advance even in a case where the flow rate of a circulation system is varied due to a difference in Duty to perform printing. As two pressure adjustment mechanisms forming the negative pressure control unit 230, any mechanism may be used as long as it is possible to control the pressure at the downstream of the negative pressure control unit 230 to be varied within a certain range based on a desirable set pressure. As an example, it is possible to adopt a mechanism similar to a so-called “depressurization regulator.” In a case where the depressurization regulator is used, as illustrated in FIG. 3, it is preferable to pressurize an upstream side of the negative pressure control unit 230 by the second circulation pump 1004 via a liquid supply unit 220. With this, it is possible to suppress an effect of a water head pressure on the liquid ejection head 3 of the buffer tank 1003, and it is possible to improve a degree of freedom of layout of the buffer tank 1003 in the printing apparatus 1000. As the second circulation pump 1004, it is possible to use a turbo type pump, an inner volume type pump, and the like as long as it has a pump head pressure equal to or greater than a certain pressure within a range of the ink circulation flow rate used during driving of the liquid ejection head 3. Specifically, a diaphragm pump and the like are applicable. Additionally, instead of the second circulation pump 1004, for example, a water head tank arranged with a certain water head difference with respect to the negative pressure control unit 230 is also applicable.

As illustrated in FIG. 3, the negative pressure control unit 230 includes the two pressure adjustment mechanisms in which different control pressures are set, respectively. In the two negative pressure adjustment-mechanisms, a relatively high pressure setting side (indicated as H in FIG. 3) is connected to a common supply channel 211 in the liquid ejection unit 300 by way of the inside of the liquid supply unit 220. Additionally, a relatively low pressure setting side (indicated as Lin FIG. 3) is connected to the common collection channel 212 by way of the inside of the liquid supply unit 220.

The liquid ejection unit 300 is provided with the common supply channel 211, the common collection channel 212, and an individual supply channel 213a and an individual collection channel 214b communicating with each printing element substrate 10. Since the individual supply channel 213a and the individual collection channel 214b communicate with the common supply channel 211 and the common collection channel 212, a flow (an arrow in FIG. 3) of a part of the ink that passes through an internal channel of the printing element substrate 10 from the common supply channel 211 and flows to the common collection channel 212 is generated. This is because, since the pressure adjustment mechanism H is connected to the common supply channel 211 while the pressure adjustment mechanism L is connected to the common collection channel 212, a differential pressure is generated between the two common channels.

Thus, in the liquid ejection unit 300, a flow in which the ink flows to pass through the inside of each of the common supply channel 211 and the common collection channel 212, and a part of the ink passes through the inside of each printing element substrate 10 is generated. Therefore, it is possible to discharge the heat generated in each printing element substrate 10 to the outside of the printing element substrate 10 by the flows in the common supply channel 211 and the common collection channel 212. Additionally, with the above-described configuration, it is possible to generate a flow of the ink also in the ejection port not performing the printing and a pressure chamber while the liquid ejection head 3 is performing the printing, and therefore it is possible to suppress thickening of the ink in the corresponding portion. Additionally, it is possible to discharge the thickened ink and a foreign substance in the ink to the common collection channel 212. Therefore, the liquid ejection head 3 of the present embodiment can perform the printing with high image quality at a high speed.

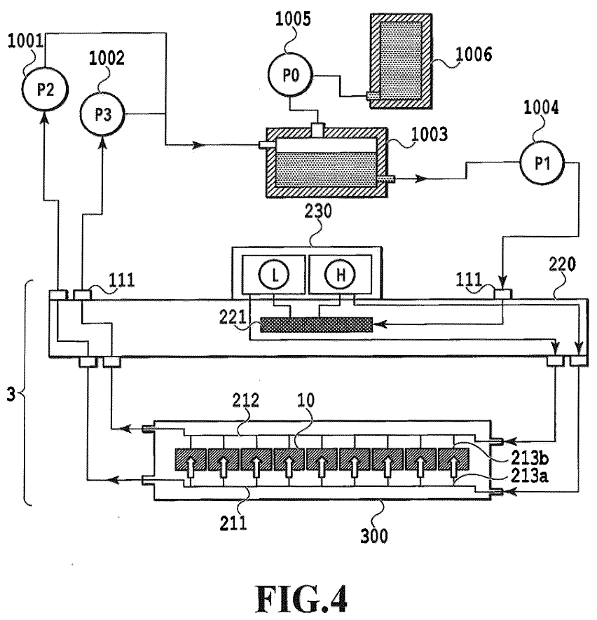

FIG. 4 is a schematic view illustrating a second circulation route, which is one of the circulation routes applied to the printing apparatus 1000 according to the present embodiment and different from the first circulation route described above. A main different point of the second circulation route is as follows.

First, the first circulation pumps 1001 and 1002 play a role of drawing out the ink from the liquid connection unit 111 of the liquid ejection head 3 and flowing the ink to the buffer tank 1003. While the liquid ejection head 3 is driven, the first circulation pump (the high pressure side) 1001 and the first circulation pump (the low pressure side) 1002 flow a certain amount of the ink in each of the common supply channel 211 and the common collection channel 212.

Since the individual supply channels 213a and 213b communicate with the common supply channel 211 and the common collection channel 212, a flow (an arrow in FIG. 4) of a part of the ink that passes through the internal channel of the printing element substrate 10 from the common supply channel 211 and flows to the common collection channel 212 is generated.

Thus, in the liquid ejection unit 300, a flow in which the ink flows to pass through the inside of each of the common supply channel 211 and the common collection channel 212, and a part of the ink passes through the inside of each printing element substrate 10 is generated.

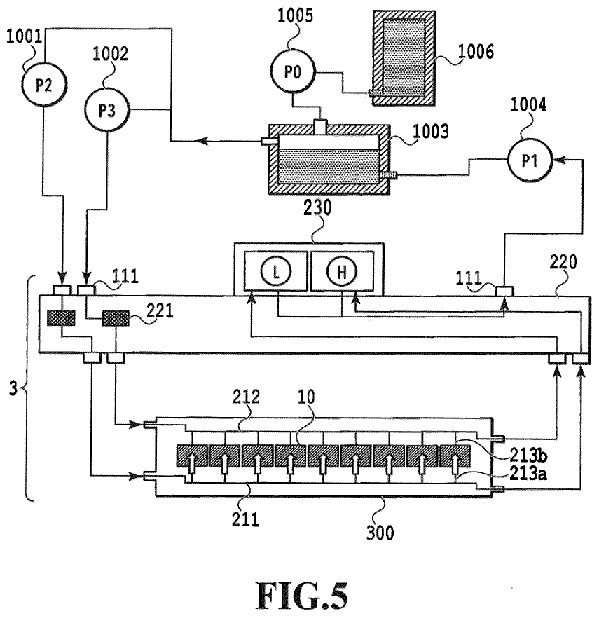

FIG. 5 is a schematic view illustrating a third circulation route, which is one of the circulation routes applied to the printing apparatus according to the present embodiment and different from the first circulation route and the second circulation route described above. A main different point of the third circulation route is as follows.

First, both the two pressure adjustment mechanisms forming the negative pressure control unit 230 include a mechanism (a mechanism component that acts similarly to a so-called “back pressure regulator”) that controls the pressure on the upstream side of the negative pressure control unit 230 to be varied within a certain range based on a desirable set pressure. Additionally, the second circulation pump 1004 acts as a negative pressure source that depressurizes the downstream side of the negative pressure control unit 230. In addition, the first circulation pump (the high pressure side) 1001 and the first circulation pump (the low pressure side) 1002 are arranged on the upstream side of the liquid ejection head, and the negative pressure control unit 230 is arranged on the downstream side of the liquid ejection head.

The negative pressure control unit 230 in the third circulation route operates such that a pressure variation on the upstream side (that is, the liquid ejection unit 300 side) of the negative pressure control unit 230 is within a certain range even in a case where the flow rate is varied due to a change in the printing Duty in a case where the liquid ejection head 3 performs the printing. The pressure variation is maintained within a certain range based on a pressure set in advance, for example. As illustrated in FIG. 5, it is preferable to pressurize the downstream side of the negative pressure control unit 230 by the second circulation pump 1004 via the liquid supply unit 220. With this, it is possible to suppress an effect of the water head pressure of the buffer tank 1003 on the liquid ejection head 3, and it is possible to improve the degree of freedom of the layout of the buffer tank 1003 in the printing apparatus 1000. Note that, instead of the second circulation pump 1004, for example, a water head tank arranged with a predetermined water head difference with respect to the negative pressure control unit 230 may be applied.

As with the first circulation route and the second circulation route, the negative pressure control unit 230 illustrated in FIG. 5 includes the two pressure adjustment mechanisms in which different control pressures are set, respectively. In the two negative pressure adjustment mechanisms, a relatively high pressure setting side (indicated as H in FIG. 5) is connected to the common supply channel 211 in the liquid ejection unit 300 by way of the inside of the liquid supply unit 220. Additionally, a relatively low pressure setting side (indicated as L in FIG. 5) is connected to the common collection channel 212 by way of the inside of the liquid supply unit 220.

The two negative pressure adjustment mechanisms increase the pressure of the common supply channel 211 relatively higher than the pressure of the common collection channel 212. With this configuration, an ink flow that flows from the common supply channel 211 to the common collection channel 212 via the individual channels 213 and the internal channel of each printing element substrate 10 is generated (an arrow in FIG. 5). Thus, in the third circulation route, although the ink flow state similar to that of the first circulation route and the second circulation route can be obtained in the liquid ejection unit 300, there are two advantages different from that in a case of the first circulation route and the second circulation route.

The first advantage is fewer concerns about flowing of the dust and the foreign substance generated from the negative pressure control unit 230 into the head because the negative pressure control unit 230 is arranged on the downstream side of the liquid ejection head 3 in the third circulation route. The second advantage is the lower maximum value of the required flow rate to be supplied from the buffer tank 1003 to the liquid ejection head 3 in the third circulation route than that in a case of the first circulation route and the second circulation route. The reason is as follows. It is assumed that the sum of the flow rates in the common supply channel 211 and the common collection channel 212 in a case of circulation while standing by for the printing is A. A value of A is defined as a minimal flow rate required to set the temperature difference in the liquid ejection unit 300 to be within a desirable range in a case of adjusting the temperature of the liquid ejection head 3 while standing by for the printing. Additionally, an ejection flow rate in a case where the ink is ejected from all the ejection ports of the liquid ejection unit 300 (in case of ejecting all) is defined as F. Accordingly, in a case of the first circulation route and the second circulation route (FIGS. 3 and 4), the set flow rates of the first circulation pump (the high pressure side) 1001 and the first circulation pump (the low pressure side) 1002 are A, and the maximum value of the liquid supply amount to the liquid ejection head 3 required for a case of ejecting all is A+F.

On the other hand, in a case of the third circulation route (FIG. 5), the liquid supply amount to the liquid ejection head 3 required in a case of standing by for the printing is the flow rate A. In addition, the supply amount to the liquid ejection head 3 required in a case of ejecting all is the flow rate F. Accordingly, in a case of the third circulation route, the total value of the set flow rates of the first circulation pump (the high pressure side) 1001 and the first circulation pump (the low pressure side) 1002, that is, the maximum value of the required supply flow rate is a greater value of either A or F. Therefore, as long as the liquid ejection unit 300 of the same configuration is used, the maximum value of the required supply amount in the third circulation route (A or F) is inevitably lower than the maximum value of the required supply flow rate in the first circulation route and the second circulation route (A+F). Accordingly, in a case of the third circulation route, a degree of freedom of the applicable circulation pump is increased. Therefore, for example, it is possible to use a circulation pump with a simple configuration and low cost and reduce a load of a cooler (not illustrated) installed in a route on a main body side, and there is an advantage that the cost of a printing apparatus main body can be reduced. This advantage is greater with a line head with a relatively greater value of A or F, and the line head with a longer length in a longitudinal direction is more beneficial.

However, in one respect, the first circulation route and the second circulation route are more advantageous than the third circulation route. To be specific, in the third circulation route, since the flow rate of the flow in the liquid ejection unit 300 becomes the maximum while standing by for the printing, a state in which the higher negative pressure is applied to each nozzle with the lower printing Duty is obtained. Therefore, particularly in a case where a channel width of the common supply channel 2il and the common collection channel 212 (a length in a direction orthogonal to a flow direction of the ink) is reduced, and a head width (a length in a transverse direction of the liquid ejection head) is reduced, a high negative pressure is applied to the nozzle with a low Duty image that easily shows the unevenness. Because of the application of the high negative pressure as described above, there is a possibility of a great effect of a satellite droplet. On the other hand, in a case of the first circulation route and the second circulation route, a timing of the application of the high negative pressure to the nozzle is during the formation of a high Duty image; for this reason, even in a case where the satellite droplet is generated, it is less visible, and there is an advantage that the effect on the printing image is small. As for the three circulation routes, it is possible to adopt a preferable option according to the specifications (the ejection flow rate F, the minimum circulation flow rate A, and a channel resistance in the head) of the liquid ejection head and the printing apparatus main body.

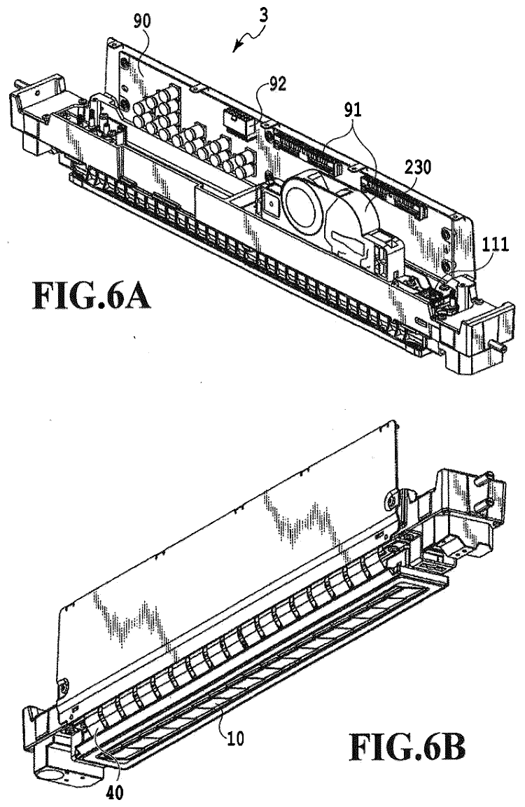

FIGS. 6A and 6B are perspective views of the liquid ejection head 3. In FIGS. 6A to 14, a mode in which a single liquid ejection head ejects four colors of the inks is described below. As illustrated in FIGS. 6A and 6B, the liquid ejection head 3 includes a signal input terminal 91 and a power supply terminal 92 that are electrically connected with each printing element substrate 10 via a flexible wiring substrate 40 and an electric wiring substrate 90. The signal input terminal 91 and the power supply terminal 92 are electrically connected with the control unit of the printing apparatus 1000, and an ejection driving signal is supplied to the printing element substrate 10 via the signal input terminal 91, while the power required for the ejection is supplied to the printing element substrate 10 via the power supply terminal 92.

Wiring is aggregated by an electric circuit in the electric wiring substrate 90, and therefore it is possible to provide a smaller number of the signal input terminals 91 and the power supply terminals 92 than the number of the printing element substrates 10. Thus, a smaller number of electric connection units are required to be detached in a case of assembling the liquid ejection head 3 in the printing apparatus 1000 or in a case of replacing the liquid ejection head 3. As illustrated in FIG. 68, the liquid connection units 111 provided to each of two end portions of the liquid ejection head 3 is connected with a liquid supply system of the printing apparatus 1000. Thus, the four colors, CMYK, of the inks are supplied from the supply system of the printing apparatus 1000 to the liquid ejection head 3, and the ink that passes through the inside of the liquid ejection head 3 is collected into the supply system of the printing apparatus 1000. Thus, each color of the ink can be circulated by way of the route of the printing apparatus 1000 and the route of the liquid ejection head 3.

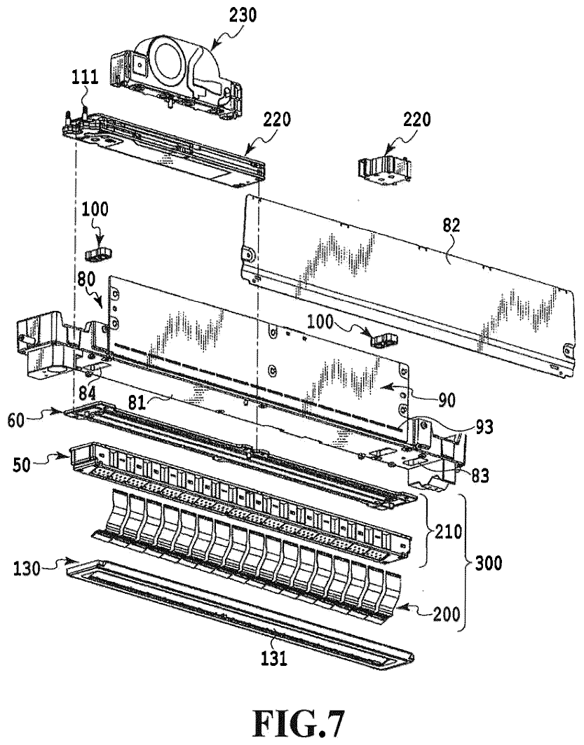

FIG. 7 is an exploded perspective view of each component or unit forming the liquid ejection head 3. The liquid ejection unit 300, the liquid supply unit 220, and the electric wiring substrate 90 are attached to a housing 80. The liquid connection unit 111 (see FIGS. 3, 4, and 5) is provided to the liquid supply unit 220. In addition, in the inside of the liquid supply unit 220, a filter 221 (see FIGS. 3, 4, and 5) for each color that communicates with each opening of the liquid connection unit 111 is provided to remove the foreign substance in the supplied ink. The two liquid supply units 220 are each provided with the filters 221 of two colors. The ink that passes through the filter 221 is supplied to the negative pressure control unit 230 arranged on the liquid supply unit 220 corresponding to each color.

The negative pressure control unit 230 is a unit formed of a pressure adjustment valve for each color. The negative pressure control unit 230 considerably attenuates a change in the pressure loss in the supply system of the printing apparatus 1000 (the supply system on the upstream side of the liquid ejection head 3) that occurs along with the variation of the flow rate of the ink by an operation of the valve, a spring member, and the like provided inside of each unit. Therefore, the negative pressure control unit 230 can stabilize the change in the negative pressure on the downstream side of the pressure control unit (the liquid ejection unit 300 side) within a certain range. In the negative pressure control unit 230 of each color, as described with reference to FIG. 5, two pressure adjustment valves for each color are built in. The pressure adjustment valves are set to different control pressures, respectively, and the high pressure side communicates with the common supply channel 211 in the liquid ejection unit 300, while the low pressure side communicates with the common collection channel 212 via the liquid supply unit 220.

The housing 80 includes a liquid ejection unit support unit 81 and an electric wiring substrate support unit 82 and supports the liquid ejection unit 300 and the electric wiring substrate 90 while securing the rigidity of the liquid ejection head 3. The electric wiring substrate support unit 82 supports the electric wiring substrate 90 and is fixed to the liquid ejection unit support unit 81 by being screwed. The liquid ejection unit support unit 81 plays a role of correcting warp and deformation of the liquid ejection unit 300 to secure the relative position accuracy of the multiple printing element substrates 10, and thus a streak and the unevenness on a printed product are suppressed. Therefore, the liquid ejection unit support unit 81 preferably has sufficient rigidity, and it is preferable to use a metal material such as SUS and aluminum or ceramic such as alumina as the material. The liquid ejection unit support unit 81 is provided with openings 83 and 84 into which joint rubber 100 is inserted. The ink supplied from the liquid supply unit 220 is guided to a third channel member 70 forming the liquid ejection unit 300 via the joint rubber.

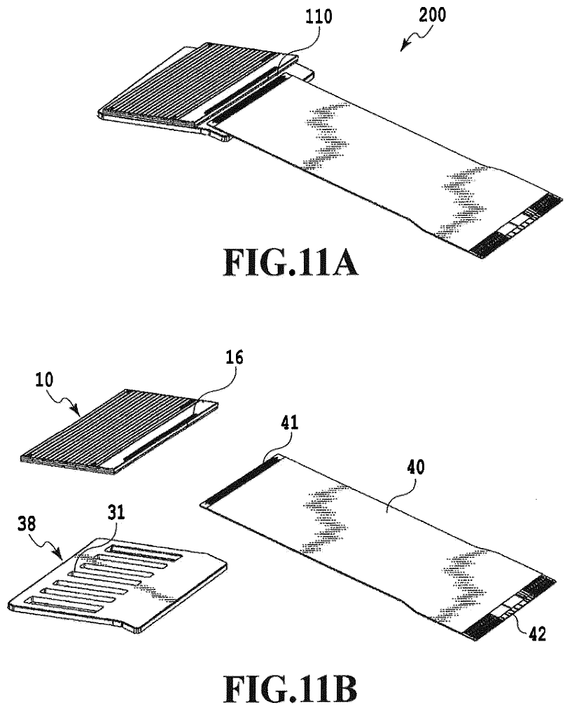

The liquid ejection unit 300 includes multiple ejection modules 200 and a channel member 210, and a cover member 130 is attached to a surface of the liquid ejection unit 300 on a printing medium side. In this case, as illustrated in FIG. 7, the cover member 130 is a member having a frame-shaped surface provided with a long opening 131, and the printing element substrate 10 and a sealing member 110 (see FIG. 11 described later) included in the ejection module 200 are exposed from the opening 131. A frame portion around the opening 131 has a function as a contact surface of a cap member that caps the liquid ejection-head 3 while standing by for the printing. Therefore, it is preferable to form a closed space while the liquid ejection head 3 is capped by applying an adhesive, a sealing member, a filler, and the like along the periphery of the opening 131 and filling an uneven portion and a gap on an ejection port surface of the liquid ejection unit 300.

Next, a configuration of the channel member 210 included in the liquid ejection unit 300 is described. As illustrated in FIG. 7, the channel member 210 is formed by laminating a first channel member 50 and a second channel member 60. The channel member 210 distributes the ink supplied from the liquid supply unit 220 to each ejection module 200 and returns the ink circulating again from the ejection module 200 to the liquid supply unit 220. The channel member 210 is fixed to the liquid ejection unit support unit 81 by being screwed, and thus warp and deformation of the channel member 210 are suppressed.

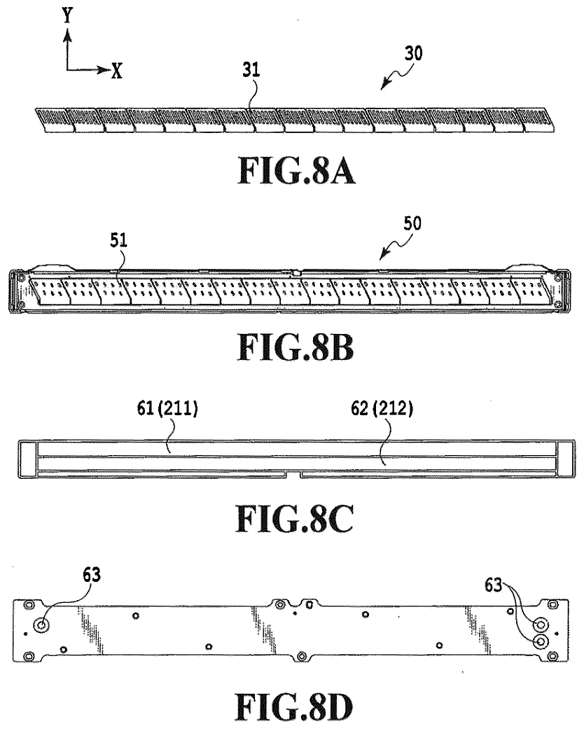

FIGS. 8A to 8D are diagrams describing a detailed configuration of the channel member 210. FIG. 8A illustrates a contact surface of a support member 38 to be in contact with the printing element substrate 10, FIG. 8B illustrates a contact surface of the first channel member 50 to be in contact with the support member 38, FIG. 8C illustrates an interlayer cross section of the first channel member, and FIG. 8D illustrates a surface of the second channel member on a liquid ejection unit support unit 81 side, respectively. Note that, FIGS. 8A to 8C are diagrams viewed from the ejection port surface, and FIG. 8D is a diagram viewed from opposite, which is the liquid ejection unit support unit 81 side. As illustrated in FIG. 8A, in the surface of the support member 38 that is brought into contact with the printing element substrate 10, a support member communication port 31 that is fluidically connected with the printing element substrate 10 to be the individual supply channel 213a and the individual collection channel 213b described in FIG. 2 is formed. As illustrated in FIG. 8B, the support member communication port 31 fluidically communicates with the common supply channel 211 or the common collection channel 212 via a communication port 51 formed in the first channel member 50.

As illustrated in FIG. 8C, on the interlayer of the first channel member 50, common channel grooves 61 and 62 extending in an X direction to be the common supply channel 211 and the common collection channel 212 described in FIGS. 3 to 5 are formed. As illustrated in FIG. 8D, a common communication port 63 fluidically communicating with the liquid supply unit 220 is formed in two end portions or one end of the common channel grooves 61 and 62.

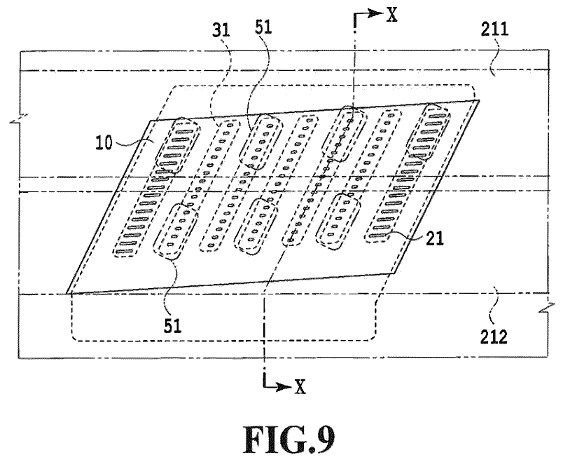

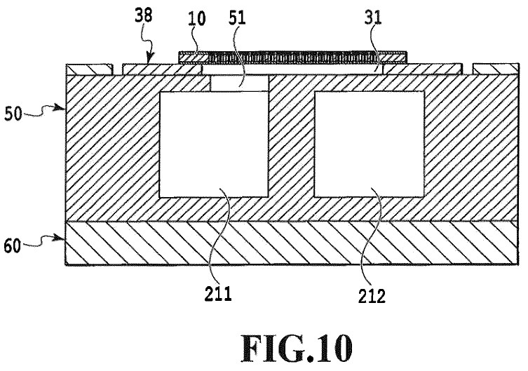

FIGS. 9 and 10 are a transparent view and a cross-sectional view describing a channel structure formed inside the channel member 210. FIG. 9 is an enlarged transparent view of the channel member 210 viewed from a Z direction, and FIG. 10 is a cross-sectional view taken along an X-X line in FIG. 9.

The printing element substrate 10 of the ejection module 200 is placed above the communication port 51 of the first channel member 50 with the support member 38 arranged therebetween. Note that, although the communication port 51 corresponding to the common collection channel 212 is not illustrated in FIG. 10, it is obvious from FIG. 8B that the communication port 51 corresponding to the common collection channel 212 is illustrated in another cross section.

As already described above, the common supply channel 211 is connected to the first negative pressure control unit 230 of the relatively high pressure, and the common collection channel 212 is connected to the second negative pressure control unit 230 of the relatively low pressure. An ink supply route through which the ink is supplied to the channel formed in the printing element substrate 10 by way of the common communication port 63 (see FIG. 8D), the common supply channel 211, and the support member communication port 31 is formed. Likewise, an ink collection route formed of the support member communication port 31, the communication port 51, the common collection channel 212, and the common communication port 63 (see FIG. 8) is formed from the channel in the printing element substrate 10. While the ink is circulated as described above, in the printing element substrate 10, an ejection operation according to ejection data is performed, and a part of the ink supplied through the ink supply route that is not consumed by the ejection operation is collected through the ink collection route.

FIG. 11A is a perspective view illustrating the single ejection module 200, and FIG. 11B is an exploded view of the ejection module 200. As a manufacturing method of the ejection module 200, first, the printing element substrate 10 and the flexible wiring substrate 40 are adhered on the support member 38 in which the support member communication port 31 is provided in advance. Thereafter, a terminal 16 on the printing element substrate 10 and a terminal 41 on the flexible wiring substrate 40 are electrically connected by wire bonding, and thereafter, a wire bonding portion (an electric connection unit) is covered and sealed with the sealing member 110. A terminal 42 on the opposite side of the flexible wiring substrate 40 on the printing element substrate 10 is electrically connected with a connection terminal 93 of the electric wiring substrate 90 (see FIG. 7). Since the support member 38 is a support body that supports the printing element substrate 10 and is a channel member that allows for the fluidical communication between the printing element substrate 10 and the channel member 210, the support member 38 preferably has a high flatness that can be bonded with the printing element substrate with sufficiently high reliability. A preferable material is alumina and resin material, for example.

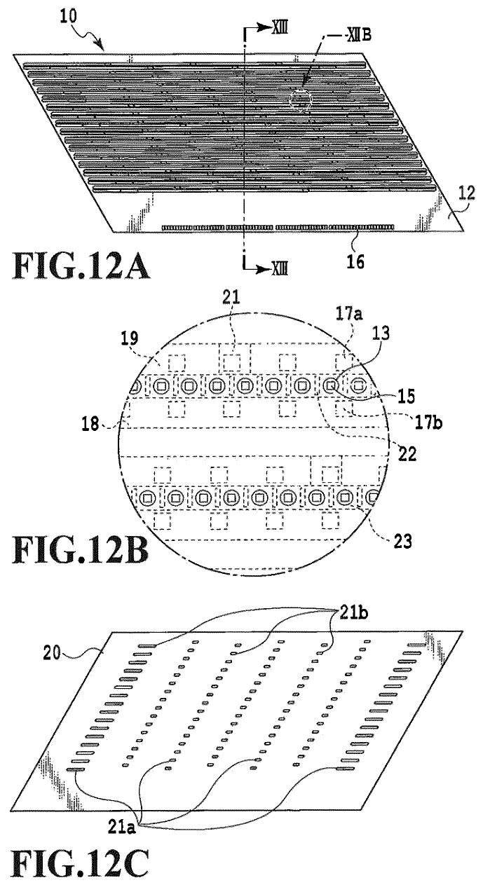

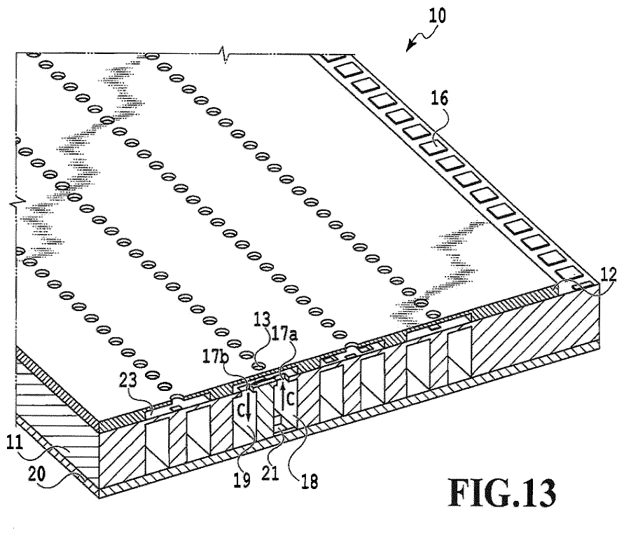

FIG. 12A is a plan view of a surface on a side of the printing element substrate 10 on which an ejection port 13 is formed, FIG. 128 is an enlarged view of a portion indicated by XIIb in FIG. 12A, and FIG. 12C is a plan view of a back surface of FIG. 12A. FIG. 13 is a perspective view illustrating a cross section of the printing element substrate 10 and a cover plate 20 taken along a cross-sectional line XIII-XIII illustrated in FIG. 12A. A configuration of the printing element substrate 10 is described below.

As illustrated in FIG. 12A, four ejection port rows corresponding to the ink colors are formed on an ejection port formation member 12 of the printing element substrate 10. Note that, hereinafter, a direction in which the ejection port row including the arrayed multiple ejection ports 13 extends is referred to as an “ejection port row direction”.

As illustrated in FIG. 12B, in a position corresponding to each ejection port 13, a printing element 15 that is a heat generation element (a heater) that generate a bubble in the ink with heating energy is arranged. A pressure chamber 23 including the printing element 15 therein is divided by a partition 22. The printing element 15 is electrically connected with the terminal 16 in FIG. 12A by electric wiring (not illustrated) provided to the printing element substrate 10. The printing element 15 generates heat and boils the ink based on a pulse signal inputted from a control circuit of the printing apparatus 1000 via the electric wiring substrate 90 (FIG. 7) and the flexible wiring substrate 40 (see FIG. 11B). The ink is ejected from the ejection port 13 by force of the bubble generation caused by the boiling. As illustrated in FIG. 12B, a liquid supply path 18 extends on one side, and a liquid collection path 19 extends on the other side along each ejection port row. The liquid supply path 18 and the liquid collection path 19 are channels provided to the printing element substrate 10 and extending in the ejection port row direction and communicate with the ejection port 13 via corresponding supply port 17a and collection port 17b.

As illustrated in FIGS. 12C and 13, the sheet-shaped cover plate 20 is laminated on a back surface of the surface of the printing element substrate 10 in which the ejection port 13 is formed, and in the cover plate 20, multiple openings 21 communicating with the liquid supply path 18 and the liquid collection path 19 described later are provided. Three openings 21 are provided for each liquid supply path 18, and two openings 21 are provided for each liquid collection path 19 in the cover plate 20. As illustrated in FIG. 12B, each opening 21 in the cover plate 20 communicates with the multiple communication ports 51 illustrated in FIG. 9 and the like. As illustrated in FIG. 13, the cover plate 20 has a function as a lid forming a part of walls of the liquid supply path 18 and the liquid collection path 19 formed on a substrate 11 of the printing element substrate 10. The cover plate 20 preferably has a sufficient corrosion resistance to the ink, and an opening shape and an opening position of the opening 21 are required to be highly accurate in terms of preventing mixing of the colors. Therefore, it is preferable to use photosensitive resin material and a silicon plate as the material of the cover plate 20, and the opening 21 is preferably provided by a photolithography process. Thus, the lid member converts a pitch of the channel by the opening 21, and it is desirable for the lid member to have a thin thickness considering a pressure loss, and it is desirable to be formed of a film-like member.

Next, a flow of the ink in the printing element substrate 10 is described. As illustrated in FIG. 13, the printing element substrate 10 is formed by laminating the substrate 11 formed of Si and the ejection port formation member 12 formed of photosensitive resin, and the cover plate 20 is bonded on a back surface of the substrate 11. The printing element 15 is formed on one surface side of the substrate 11 (see FIG. 12B), and grooves forming the liquid supply path 18 and the liquid collection path 19 extending along the ejection port row are formed on the back surface side. The liquid supply path 18 and the liquid collection path 19 formed by the substrate 11 and the cover plate 20 are connected with the common supply channel 211 and the common collection channel 212 in the channel member 210, respectively, and a differential pressure is generated between the liquid supply path 18 and the liquid collection path 19.

While the ink is ejected from the multiple ejection ports 13 of the liquid ejection head 3, and the printing is performed, in the ejection port performing no ejection operation, a flow of the ink in the liquid supply path 18 provided in the substrate 11 is a flow indicated by an arrow C in FIG. 13 due to the differential pressure. That is, the ink flows to the liquid collection path 19 by way of the supply port 17a, the pressure chamber 23, and the collection port 17b. With this flow, the thickened ink generated by evaporation from the ejection port 13 and a bubble, a foreign substance, and the like in the ejection port 13 in which the printing is stopped and the pressure chamber 23 can be collected into the liquid collection path 19. Additionally, it is possible to suppress thickening of the ink in the ejection port 13 and the pressure chamber 23. The ink collected in the liquid collection path 19 is collected to the communication port 51, the individual collection channels 214, and the common collection channel 212 in the channel member 210, sequentially, through the opening 21 of the cover plate 20 and the support member communication port 31 of the support member 38 (see FIG. 11B). This ink is eventually collected into the supply route of the printing apparatus 1000.

That is, the ink supplied from the printing apparatus main body to the liquid ejection head 3 flows in the order described later to be supplied and collected. First, the ink flows to the inside of the liquid ejection head 3 from the liquid connection unit 111 of the liquid supply unit 220. Then, the ink is supplied to the joint rubber 100, a communication port 72 and a common channel groove 71 provided to the third channel member, a common channel groove 62 and a communication port 61 provided to the second channel member, and an individual channel groove 52 and the communication port 51 provided to the first channel member, in this order. Thereafter, the ink is supplied to the pressure chamber 23 via the support member communication port 31 provided in the support member 38, the opening 21 provided in the cover plate 20, and the liquid supply path 18 and the supply port 17a provided to the substrate 11, subsequently.

A part of the ink supplied to the pressure chamber 23 that is not ejected from the ejection port 13 flows through the collection port 17b and the liquid collection path 19 provided to the substrate 11, the opening 21 provided in the cover plate 20, and the support member communication port 31 provided in the support member 38, sequentially. Thereafter, the ink flows through the communication port 51 and the individual channel groove 52 provided to the first channel member, the communication port 61 and the common channel groove 62 provided to the second channel member, the common channel groove 71 and the communication port 72 provided to the third channel member 70, and the joint rubber 100, sequentially. In addition, the ink flows from the liquid connection unit 111 provided to the liquid supply unit to the outside of the liquid ejection head 3. In the mode of the first circulation route illustrated in FIG. 3, the ink that flows from the liquid connection unit 111 is supplied to the joint rubber 100 after passing through the negative pressure control unit 230. In the mode of the third circulation route illustrated in FIG. 5, after the ink collected from the pressure chamber 23 passes through the joint rubber 100, the ink flows from the liquid connection unit 111 to the outside of the liquid ejection head via the negative pressure control unit 230.

Additionally, as illustrated in FIGS. 4 and 5, not all the ink that flows from one end of the common supply channel 211 of the liquid ejection unit 300 is supplied to the pressure chamber 23 by way of the individual supply channel 213a. There is also the ink that flows from the other end of the common supply channel 211 to the liquid supply unit 220 without flowing into the individual supply channel 213a. Thus, a route of a flow that does not pass through the printing element substrate 10 is provided, and therefore it is possible to suppress a backward flow of the circulation flow of the ink even in a case where the printing element substrate 10 including the fine channel with a great flow resistance as described in the present embodiment. Thus, in the liquid ejection head of the present embodiment, since it is possible to suppress the thickening of the ink in the pressure chamber and a portion near the ejection port, it is possible to suppress deviation from the normal direction of the ejection direction and non-ejection of the ink, and eventually it is possible to perform the printing with high image quality.

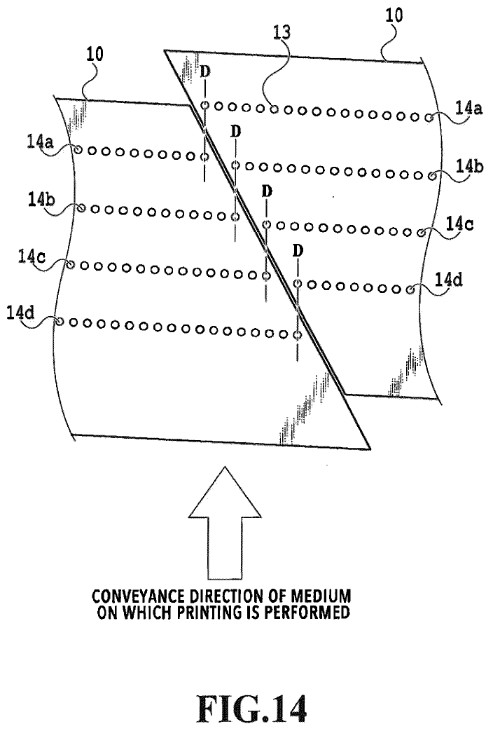

FIG. 14 is a plan view illustrating a partially enlarged adjacent portion of the printing element substrate in adjacent two ejection modules. As illustrated in FIG. 12A and the like, a printing element substrate having substantially a parallelogram shape is used in the present embodiment. As illustrated in FIG. 14, the ejection port rows (14a to 14d) in which the ejection ports 13 are arrayed in the printing element substrate 10 are arranged to be tilted at a certain angle with respect to the conveyance direction of the medium on which the printing is performed. Thus, in the ejection port rows in the adjacent portions of the printing element substrates 10, at least one ejection port overlaps the other in the conveyance direction of the medium on which the printing is performed. In FIG. 14, the two ejection ports on a D line have the overlapping relationship. With the above-described arrangement, even in a case where the position of the printing element substrate 10 is displaced from a predetermined position for instance, it is possible to obscure a black streak and a blank dot on the printing image by controlling driving of the overlapping ejection ports. The configuration as illustrated in FIG. 14 can be applied also in a case where the multiple printing element substrates 10 are arranged on a straight line (in-line) instead of being arranged in a staggered manner. Thus, it is possible to provide measures against the black streak and the blank dot in a connection portion between the printing element substrates 10 while suppressing an increase in the length in the conveyance direction of the medium on which the printing is performed in the liquid ejection head. Note that, although a principal plane of the printing element substrate in this case is a parallelogram, the present embodiment is not limited thereto, and the configuration of the present embodiment is preferably applicable also in a case of using a printing element substrate having a rectangle shape, a trapezoid shape, and another shape, for example.

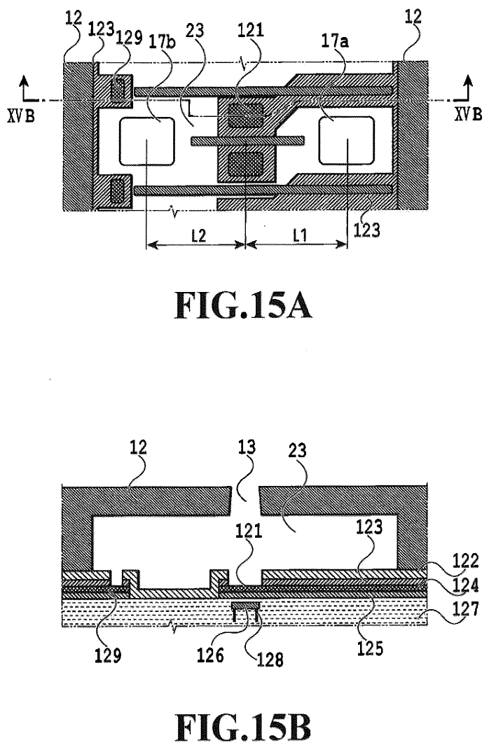

FIGS. 15A and 15B are diagrams illustrating a heat acting portion in the printing element substrate according to the present embodiment. FIG. 15A is a plan view schematically illustrating the enlarged vicinity of the heat acting portion in the printing element substrate 10. Additionally, FIG. 15B is a cross-sectional view taken along a dash-dotted line XVb-XVb in FIG. 15A.

In the liquid ejection head, multiple layers are laminated on a base substrate formed of silicon to form the substrate for the liquid ejection printing. In the present embodiment, a heat accumulation layer formed of a thermal oxide film, a SiO film, a SiN film, and the like is arranged on the base substrate. Additionally, a heat generation resistor 126 is arranged on the heat accumulation layer, and an electrode wiring layer (not illustrated) as wiring formed of a metallic material such as Al, Al—Si, and Al—Cu is connected to the heat generation resistor 126 via a tungsten plug 128. As illustrated in FIG. 15B, an insulating protection layer 127 is arranged on the heat generation resistor 126. The insulating protection layer 127 is an insulating layer provided on the top of the heat generation resistor 126 to cover the heat generation resistor 126. The insulating protection layer 127 is formed of a SiO film, a SiN film, and the like.

A protection layer that blocks contact with the liquid is arranged on the insulating protection layer 127. The protection layer is formed of a lower portion protection layer 125, an upper portion protection layer 124, and a close-contact protection layer 123 and protects a surface of the heat generation resistor 126 from chemical and physical impacts along with the heat generation by the heat generation resistor 126.

In the present embodiment, the lower portion protection layer 125 is formed of tantalum (Ta), the upper portion protection layer 124 is formed of iridium (Ir), and the close-contact protection layer 123 is formed of tantalum (Ta). Additionally, the protection layer formed of the above-described materials has electric conductivity. A protection layer 122 that is liquid resistant and improves the close contactness with the ejection port formation member 12 is arranged on the close-contact protection layer 123. The protection layer 122 is formed of SiC. The upper portion protection layer 124 is⋅formed of a material that includes a metal eluted by an electric chemical reaction and that does not form an oxide film that prevents elution by heat.

In a region corresponding to the heat generation resistor 126, an upper surface of the upper portion protection layer 124 is put in contact with the liquid, and it is a harsh environment in which the temperature of the liquid rises instantaneously to generate a bubble on the surface, then the bubble disappears, and cavitation occurs in the same place. Therefore, in the present embodiment, the upper portion protection layer 124 formed of the iridium material having high corrosion resistance and high reliability is formed and put in contact with the liquid.

In the present embodiment, the ink circulation configuration in which the liquid is supplied from the supply port 17a, and the liquid is collected into the collection port 17b is adopted in the pressure chamber 23. Accordingly, on the heat generation resistor 126, the liquid flows in a direction from the supply port 17a on the upstream side to the collection port 17b on the downstream side during the printing.

Conventionally, kogation removal processing to remove kogation by eluting the heater surface by generating an electric chemical reaction with the ink has been known as a method of removing kogation produced on the heater (see Japanese Patent Laid-Open No. 2008-105364). Additionally, in the present embodiment, in addition to the conventional kogation removal processing, kogation suppression processing to suppress kogation accumulated on the upper portion protection layer 124 on the heat generation resistor 126 is performed during the printing. As a detailed description, a portion of the upper portion protection layer 124 immediately above the heat generation resistor 126 is one electrode 121 (a first electrode), and an opposing electrode 129 (a second electrode) conductible with the electrode 121 via the liquid is provided to form an electric field via the liquid in the liquid chamber. Thus, particles of charged pigments and the like in the liquid are caused to repel against the surface of the upper portion protection layer 124 on the heat generation resistor 126. Thus, an existence rate of the particles of the charged pigments and the like near the surface of the upper portion protection layer 124 is reduced, and therefore the kogation accumulated on the upper portion protection layer 124 on the heat generation resistor 126 during the printing is suppressed. It is considered in the kogation suppression that the kogation is a phenomenon that occurs because a color material, an additive, and so on included in the liquid are degraded at a molecular level by being heated at high temperature, changed into a substance with low solubility, and physically adsorbed onto the upper portion protection layer. The reduction of the existence rate of the color material, the additive, and so on that cause the kogation near the surface of the upper portion protection layer 124 on the heat generation resistor 126 in a case where the upper portion protection layer 124 is heated at high temperature results in the kogation suppression.

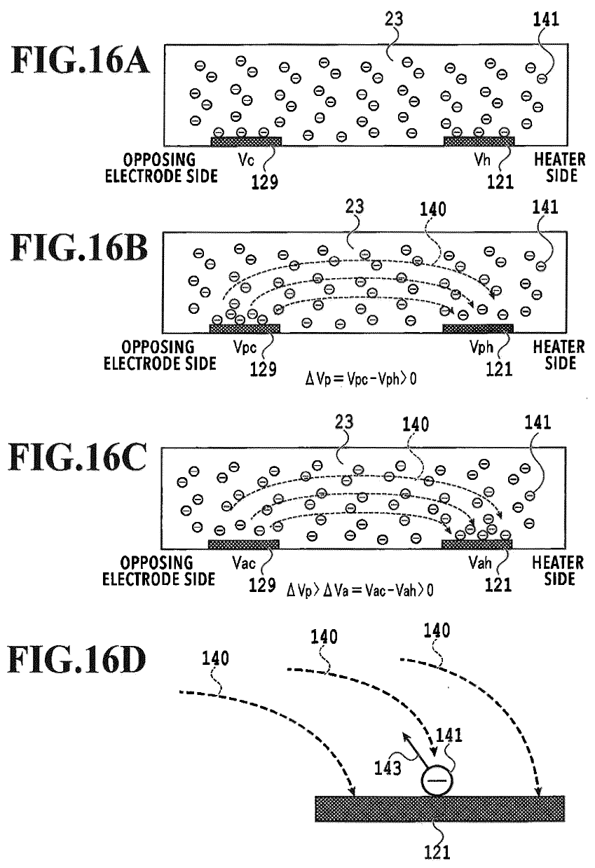

FIG. 16 is a diagram illustrating electric field control in the pressure chamber. A mechanism of the electric field control (also referred to as potential control or potential difference control) used in the present embodiment is described below with reference to FIG. 16. In FIG. 16A, the electrode 121 of the upper portion protection layer and the opposing electrode 129 (a protection portion) are arranged in the pressure chamber, and the pressure chamber is filled with the liquid. The liquid contains particles 141 of the pigments and the like charged to a negative potential, and the particles 141 are dispersed substantially uniformly in the liquid. In FIG. 16A, there is no potential difference between the potential of the electrode 121 of the upper portion protection layer and the potential of the opposing electrode 129.

FIG. 16B illustrates a state in which a voltage is applied such that the potential of the electrode 121 of the upper portion protection layer is relatively lower (to a negative pole) than the potential of the opposing electrode 129 during the printing. FIG. 16C illustrates a state during the aging processing in which the potential difference between the electrode 121 and the opposing electrode 129 is smaller than the potential difference between the electrode 121 and the opposing electrode 129 during the printing.

For example, in FIG. 16B, the potential difference between the electrode 121 and the opposing electrode 129 is about 0.5 to 2.5 V (0.5 V or greater and 2.5 V or smaller). This is because, in a case where the upper portion protection layer 124 is formed of iridium, once the potential difference between the two electrodes exceeds 2.5 V, an electric chemical reaction occurs between the electrode 121 and the liquid, which causes the elution of the surface of the electrode 121 to the liquid, and therefore it is preferable to set the potential difference that does not cause the elution of the electrode 121. That is, in the present embodiment, it is preferable to satisfy the following expressions:

|ΔVa|≤2.5 V Expression (1);

|ΔVp|≤2.5 V Expression (2).

In this case, ΔVa is a potential difference between a potential Vh of the electrode 121 and a potential Vc of the opposing electrode during the aging processing (ΔVa=Vac−Vah). Additionally, ΔVp is a potential difference between the potential Vh of the electrode 121 and the potential Ve of the opposing electrode during the printing (ΔVp=Vpc−Vph). In this case, it is a state in which an electric field 140 is formed between the electrode 121 of the upper portion protection layer and the opposing electrode 129 via the liquid, but no current flows. Since the electrode 121 of the upper portion protection layer is at a relatively negative potential with respect to the opposing electrode 129, the particles 141 charged to the negative potential repel against the surface of the electrode 121 of the upper portion protection layer, and the existence rate of the particles 141 near the surface of the electrode 121 of the upper portion protection layer is reduced.

FIG. 16D is a schematic view of the enlarged vicinity of the upper portion protection layer illustrated in FIG. 16B. The particles 141 charged to the negative potential repel against the surface of the electrode 121 of the upper portion protection layer by repulsion 143 along an electric line of force of the electric field 140 formed in the liquid.

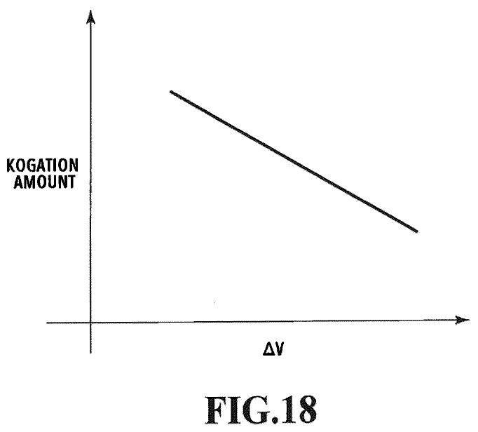

With the above-described mechanism, in the present embodiment, the greater the potential difference ΔV (=|Vc−Vh|), where the potential of the opposing electrode is Vc, and the potential of the electrode of the upper portion protection layer of the heater is Vh, the more the particles 141 charged to the negative potential that produces the kogation repel against the electrode 121. In addition, a kogation amount adhered to the electrode 121 is reduced. A relationship between ΔV and the kogation amount in the present embodiment is as illustrated in FIG. 18 described later.

However, in the above-described head configuration, in a case where the potential difference between the electrode 121 of the upper portion protection layer and the opposing electrode 129 is set to the same potential difference as that during the printing, and the initial aging processing is executed, the charged particles 141 that cause the kogation move away from the upper portion protection layer 124, and therefore the kogation is unlikely to be produced on the upper portion protection layer 124. For this reason, the initial aging processing for the purpose of uniformly applying a certain amount of the kogation takes time, and problems such as increased downtime and increased waste ink occur.

The present embodiment provides a method to solve the above-described problems. As a detailed description, in a case where the potential difference during the printing is ΔVp, and the potential difference during the aging processing is ΔVa, the conditions of ΔVp>0 and ΔVa<ΔVp are satisfied as illustrated in FIGS. 16B and 16C.

Note that, ΔVp=the potential Vpc of the opposing electrode 129 during the printing−the potential Vph of the electrode 121 of the upper portion protection layer of the heater during the printing, and ΔVa=the potential Vac of the opposing electrode during the aging processing−the potential Vah of the electrode 121 of the upper portion protection layer of the heater during the aging processing. With ΔVa (smaller than ΔVp) being adopted as the potential difference during the aging processing, the kogation is more likely to be produced on the upper portion protection layer of the heater than a case of adopting the ΔVp.

According to the above-described method, during the aging processing, since the particles charged to the negative potential are drawn toward the electrode 121 of the upper portion protection layer of the heater, burning is easily caused, and it is possible to shorten the aging processing time (time until the ejection speed stabilizes).

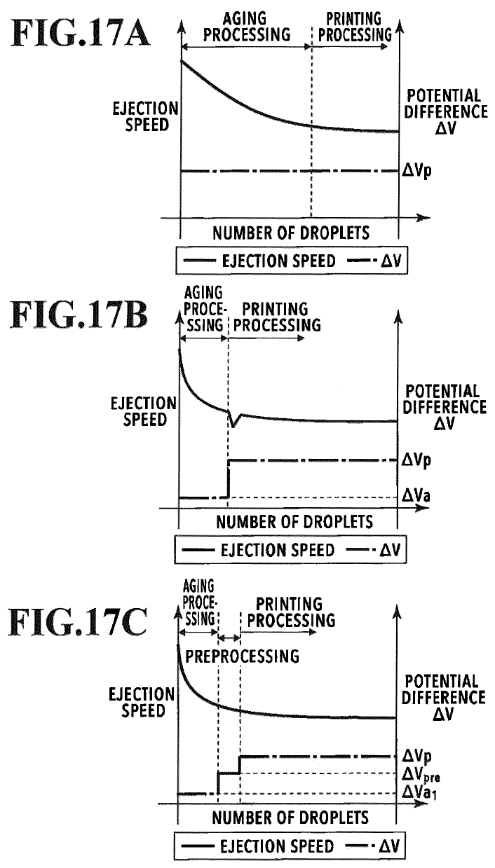

FIGS. 17A to 17C are diagrams illustrating a change in the ejection speed in a case where the aging processing is executed. FIG. 17A is a diagram illustrating an initial change in the ejection speed in a case where the aging processing is executed by adopting the same potential difference ΔVp (ΔVp>0, specifically +0.5 to 2.5 V) as that during the printing for the potential difference between the potential of the electrode 121 of the upper portion protection layer of the heater and the potential of the opposing electrode 129. In this case, it is assumed that the ejection speed stabilizes substantially at the point where the ejection speed is decreased by about 5 to 10% with respect to the initial ejection speed in a state with no kogation. In a case where the aging processing is performed with the potential difference ΔVp, which is the same as that during the printing, about 1×10⁷ times of the ejection operations are required for the aging processing until the ejection speed stabilizes as described above.

On the other hand, FIG. 17B is a diagram illustrating a change in the ejection speed in a case where the potential difference ΔVa smaller than the potential difference during the printing (ΔVa<ΔVp) is adopted during the aging processing, and the potential difference ΔVp is adopted during the printing for the potential difference between the potential of the electrode 121 of the upper portion protection layer of the heater and the potential of the opposing electrode 129.

In a case where the potential difference ΔVa smaller than the potential difference during the printing (ΔVa<ΔVp) is adopted during the aging processing, the number of ejections required for the aging processing reaches about 5×10⁶ times until the ejection speed stabilizes as described above. That is, it is possible to reach the target ejection speed in a short time, and it is possible to stabilize the ejection speed promptly. Accordingly, it is possible to shorten the time to complete the aging processing, and it is possible to reduce the downtime and the amount of the waste ink.

Additionally, since the potential difference during the printing after the aging processing is ΔVp, the state returns to a state in which burning is unlikely to occur in a case where the printing period is long, and it is possible to suppress the image deterioration with almost no change in the ejection speed.

Note that, in the present embodiment, as a method of changing the potential difference ΔV between the potential of the electrode 121 of the upper portion protection layer of the heater and the potential of the opposing electrode 129, either one of the potentials of the electrode 121 of the upper portion protection layer of the heater and the opposing electrode 129 may be changed, or both may be changed. Note that, in a case of a configuration that can change the potential difference 8 V by changing either one of the potentials of the electrodes, it is possible to simplify the circuit configuration, and therefore there is a cost advantage.

Additionally, a case where the aging processing is performed on the upper portion protection layer of the heater also includes a case of a state in which kogation removal is executed while using the printing apparatus as described above, in addition to a case where a state of the printing apparatus is brand-new having no ejection history. Moreover, a case where a kogation state on an upper layer of the heater of a target nozzle is a state of relatively less kogation comparing to a kogation state of a nozzle around the target nozzle is also included. Note that, as for the state of the printing apparatus, since the state of the brand-new state having no ejection history and the state after executing the kogation removal while using the printing apparatus are different, the kogation amounts on the upper portion protection layer of the heater are usually different between the states. Accordingly, it is also possible to use different ΔVa between the state having no ejection history and the state in which the kogation removal is executed.

Additionally, as for the control of the kogation amount during the aging processing, the management using the number of droplets (also referred to as dot count) is preferable.

Note that, as a method of determining whether the aging processing has been executed properly, for example, there is a method of confirming the density of an outputted product by printing an image at a uniform density for the determination. As a means for the density confirmation, a density sensor provided to the printing apparatus main body may be used for the confirmation, or visual confirmation may be applied.

FIG. 18 is a graph illustrating a relationship between the kogation amount adhered during the aging processing and the potential difference ΔV during the aging processing on the surface of the electrode 121 of the upper portion protection layer of the heater. As illustrated in FIG. 18, the greater the potential difference ΔV, the smaller the kogation amount. It is possible to figure out the relationship between the potential difference ΔV and the ejection speed from the relationship between the potential difference ΔV and the kogation amount in the present embodiment according to the graph in FIG. 18. In FIG. 18, the greater the potential difference ΔV, the smaller the kogation amount, and the greater the potential difference ΔV, the higher the ejection speed.

During the aging processing, the potential difference ΔVa smaller than the potential difference ΔVp during the printing is adopted, and during the printing after the aging processing, the printing is performed with the potential difference ΔVp. In this case, it is necessary to be careful in a case where the potential difference 11Va during the aging processing is changed to the potential difference ΔVp during the printing. That is, a rapid change in the potential difference causes a rapid change in the adhesion of the kogation to the upper portion protection layer of the heater. In this case, for example, the kogation adhered during the aging processing may be suddenly removed, or the adhesion of the kogation may become uneven. Thus, in a case where the kogation is removed during the ejection or the adhesion of the kogation becomes uneven, the ejection characteristics are changed, and in some cases, image unevenness and the like occur, and the printing quality is degraded.

Therefore, in the present embodiment, preprocessing is performed between the aging processing and the printing, and the potential difference ΔVa is brought close to the potential difference ΔVp gradually by the preprocessing. The method is described below.

In this case, FIG. 17C is a diagram illustrating a change in the ejection speed in a case where a potential difference ΔVa₁ smaller than the potential difference during the printing (ΔVa₁<ΔVp) is adopted during the aging processing, a potential difference ΔVpre smaller than the potential difference during the printing (ΔVpre<ΔVp) is adopted during the preprocessing performed before the printing, and the potential difference ΔVp is adopted during the printing for the potential difference between the potential of the electrode 121 of the upper portion protection layer of the heater and the potential of the opposing electrode 129.

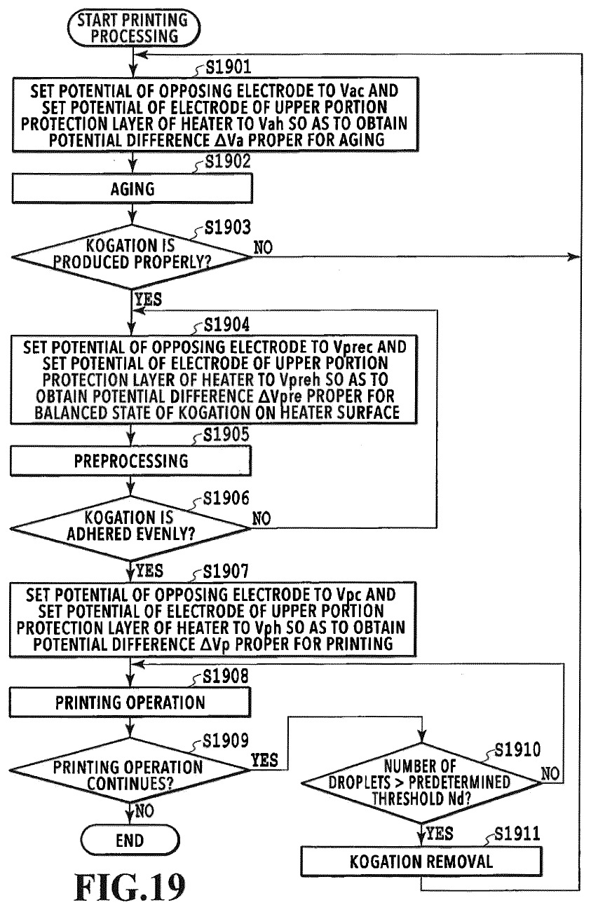

FIG. 19 is a flowchart illustrating a series of printing processing in the present embodiment. The series of the processing illustrated in FIG. 19 is performed with the CPU 30a of the liquid ejection apparatus 1000 deploying a program code stored in the ROM 30c to the RAM 30b to execute. Alternatively, a function of a part of or all the steps in FIG. 19 may be implemented by hardware such as an ASIC or an electronic circuit. In the present processing, the aging processing is executed on the liquid ejection head included in the printing apparatus in the brand-new state having no ejection history, and the printing processing is executed after the aging processing. Note that, a sign “S” in the description of each processing means that it is a step in the flowchart. The printing processing in the present embodiment is described below with reference to the flowchart in FIG. 19.

Once a printing command is received, in S1901, the CPU 30a sets the potential of the electrode 121 to Vah and sets the potential of the opposing electrode 129 to Vac such that the potential difference between the potential of the electrode 121 of the upper portion protection layer of the heater and the potential of the opposing electrode 129 becomes the optimum potential difference ΔVa during the aging processing. In S1902, the CPU 30a performs the aging processing with the potential difference ΔVa. In S1903, the CPU 30a determines whether the kogation is properly produced on the upper portion protection layer of the heater. In the present step, as described above, the printing for the determination is performed, in which a measured density is obtained by confirming the density of the outputted product, and the determination is performed based on whether the measured density is within a predetermined range. That is, it is determined that the kogation is properly produced if the measured density is within the predetermined range.

If it is determined in S1903 that the kogation is properly produced, the processing proceeds to S1904. On the other hand, if it is not determined in S1903 that the kogation is properly produced, the processing returns to S1901, and the processing is repeated.

In S1904, the CPU 30a sets the potential of the electrode 121 of the upper portion protection layer of the heater to Vpreh and sets the potential of the opposing electrode 129 to Vprec so as to obtain the potential difference ΔVpre proper for the preprocessing. In this case, it is assumed that Vpreh and Vprec satisfy a relationship of 11Va<Vprec−Vpreh<11Vp. In S1905, the CPU 30a performs the preprocessing. Specifically, a predetermined number of times of the ejection operations are performed under the potential difference (Vprec−Vprch). The preprocessing may be executed multiple times while gradually changing the potential difference (|Vprec−Vpreh|) to be close to ΔVp from ΔVa. In S1906, the CPU 30a determines whether the kogation is evenly adhered on the upper portion protection layer of the heater. The method of the determination is similar to the determination in S1903. If the kogation is evenly adhered, the processing proceeds to S1907, and if the kogation is not evenly adhered, the processing proceeds to S1904.

In S1907, the CPU 30a sets the potential of the electrode 121 of the upper portion protection layer of the heater to Vph and sets the potential of the opposing electrode 129 to Vpc so as to obtain the potential difference 11Vp proper for the printing. In S1908, the CPU 30a performs the printing operation. That is, the ejection operation according to the received printing command is performed. In S1909, the CPU 30a determines whether to continue the printing operation. If the printing operation continues, the processing proceeds to S1910, and if the printing operation does not continue, the printing processing ends. In S1910, the CPU 30a determines whether the number of droplets after the last kogation removal processing is performed is greater than a predetermined threshold (Nd). If the number of droplets is greater than the predetermined threshold, the processing proceeds to S1911. If the number of droplets is not greater than the predetermined threshold, the processing proceeds to S1908.

In S1911, the CPU 30a executes the kogation removal. The method described in Japanese Patent Laid-Open No. 2008-105364 may be adopted for the kogation removal.

After the kogation removal in S1911, the kogation is removed from the upper portion protection layer of the heater, and a state with almost no kogation is obtained; thus, the processing proceeds to S1901 and S1902. That is, the aging processing is executed again. Note that, as for the value of the potential difference ΔVa during the second and subsequent aging processing as described above, a different value from that during the initial aging processing for the brand-new head having no ejection history may be used as described above.

Additionally, in order to further shorten a required time for the aging processing, a pulse of a greater voltage value than the voltage pulse in normal times such as during the printing may be applied without damaging the heat generation element (the heater). Moreover, during the aging processing, the pulse may be applied for a longer time than a time to apply the pulse during the printing.

Furthermore, although a head for printing using the four colors of inks of CMYK (cyan, magenta, yellow, and black) is described as an example of the liquid ejection head 3 in the present embodiment, the aging processing may not be performed for a color that is unlikely to be burnt. Additionally, since the ink colors include a color that is likely to be burnt and a color that is unlikely to be burnt, the values of ΔVa, ΔVpre, and ΔVp for each ink color may not be the same and may be a combination of different values for each ink color.

For example, the aging processing may be executed with ΔVa=0, and the preprocessing may use a potential difference that is 0 V<ΔVpre≤ΔVp≤2.5 V. Note that, it is preferable that the number of ejections during the aging processing is 1×10⁷ times at the maximum, and the number of ejections during the preprocessing is about 1×10⁷ at the maximum.

Moreover, during the aging processing and during the preprocessing, it is preferable to execute temperature adjustment to further speed up the change in the state of the heater surface. For example, it is preferable to adjust the temperature within a range from 30° C. to 50° C.

Thus, between the aging processing and the printing processing, the preprocessing is performed with the potential difference between the potential difference during the aging processing and the potential difference during the printing processing. Thus, it is possible to provide a technique that can suppress the occurrence of the image unevenness and the like.

### Second Embodiment

A second embodiment of the present disclosure is described below with reference to the drawings. Note that, since the basic configuration of the present embodiment is similar to that in the first embodiment, a characteristic configuration is described below.

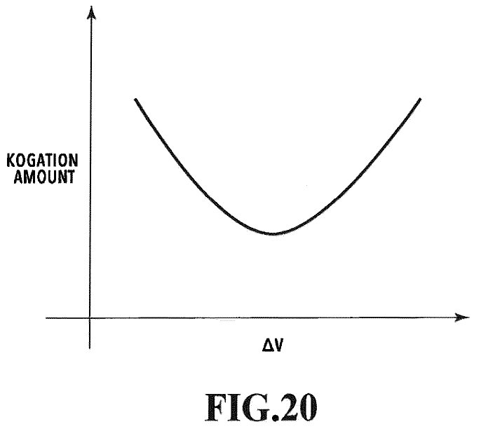

FIG. 20 is a graph illustrating a relationship between the kogation amount on the surface of the electrode 121 and the potential difference ΔV in the present embodiment. In the first embodiment, it is described that the negatively charged particles that cause the kogation repel against the surface of the electrode 121 by repulsion. As the potential of the electrode 121 of the upper portion protection layer of the heater becomes relatively negative, the potential of the opposing electrode 129 becomes relatively positive. Therefore, the negatively charged particles 141 are likely to move toward an opposing electrode 129 side and are likely to be burnt on the opposing electrode 129. In a case where the burning on the opposing electrode 129 is increased, the opposing electrode 129 and the ink are insulated from each other, and the electric field becomes gradually close to zero to be a state in which the potential control does not work. In a case where ΔV is increased in a state in which the potential control does not work, the kogation amount on the surface of the electrode 121 is increased. Because of the above-described reason, it is considered that the kogation amount has the minimal value with respect to the potential difference ΔV as illustrated in FIG. 20.

Based on the above, in the present embodiment, the potential difference is ΔVp>0, ΔVa>ΔVp. That is, as for the potential difference ΔVp between the potential of the opposing electrode 129 and the potential of the electrode 121 of the upper portion protection layer of the heater during the printing, a_value that causes less accumulation of the kogation even in a long time use, that is, a value that allows the kogation amount to be the minimal value is applied. On the other hand, as for the potential difference ΔVa between the potential of the opposing electrode 129 and the potential of the electrode 121 of the upper portion protection layer of the heater during the aging, a value greater than the value of ΔVp that allows the kogation amount to be the minimal value (ΔVa>ΔVp) is applied.

Based on the above, between the aging processing and the printing processing, the preprocessing is performed with the potential difference between the potential difference during the aging processing and the potential difference during the printing processing. Thus, it is possible to provide a technique that can suppress the occurrence of the image unevenness and the like.

### Third Embodiment

A third embodiment of the present disclosure is described below with reference to the drawings. Note that, since the basic configuration of the present embodiment is similar to that in the first embodiment, a characteristic configuration is described below.

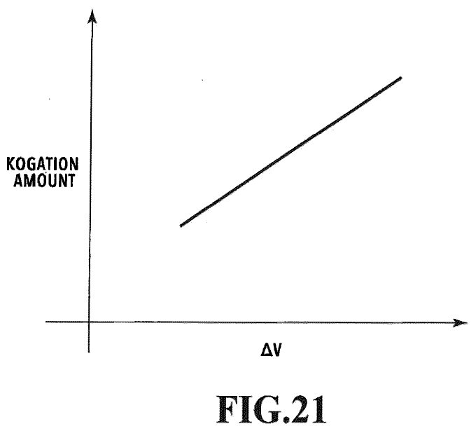

FIG. 21 is a graph illustrating a relationship between the kogation amount on the surface of the electrode 121 and the potential difference ΔV in the present embodiment. In the first embodiment, it is described that the negatively charged particles that cause the kogation repel against the surface of the electrode 121 by repulsion. The particles that cause the kogation are usually negatively charged; however, in rare cases, the particles are positively charged. In a case of the positively charged particles (to a positive pole), as the potential of the electrode 121 of the upper portion protection layer of the heater is relatively negative, the positively charged particles are likely to move close to the upper portion protection layer of the heater and are likely to be burnt on the upper portion protection layer of the heater.

Therefore, in the present embodiment, the potential difference is ΔVp<0, ΔVa>ΔVp. That is, as for the potential difference ΔVp between the potential of the opposing electrode 129 and the potential of the electrode 121 of the upper portion protection layer of the heater during the printing, a value that causes less accumulation of the kogation even in a long time use, that is, a value that is as small as possible to be ΔVp<0 is preferable. On the other hand, as for the potential difference ΔVa between the potential of the opposing electrode and the potential of the electrode of the upper portion protection layer of the heater during the aging processing, it is preferable to apply a value greater than the value of the potential difference ΔVp that allows for less kogation (ΔVa>ΔVp). Note that, the potential difference ΔVa may be either ΔVa>0 or ΔVa<0.

Thus, between the aging processing and the printing processing, the preprocessing is performed with the potential difference between the potential difference during the aging processing and the potential difference during the printing processing, while the potential difference during the printing processing ΔVp<0, and the potential difference during the aging processing ΔVa>the potential difference ΔVp during the printing processing are applied. Therefore, it is possible to provide a technique that can suppress the occurrence of the image unevenness and the like.

### Fourth Embodiment

In each embodiment described above, a mode in which the potential difference Δ Va during the aging processing and the potential difference ΔVp during the printing are different for the potential difference between the potential of the electrode 121 of the upper portion protection layer of the heater and the potential of the opposing electrode 129 is described; however, the potential of each electrode may be set arbitrarily. That is, the aging processing and the printing may be performed with a fixed potential of the electrode 121 of the upper portion protection layer of the heater (Vah=Vph). Alternatively, the aging processing and the printing may be performed with a fixed potential of the opposing electrode 129 (Vac=Vpc).

Additionally, all the values of Vac, Vah, Vpc, and Vph may be 0 or greater.

### Fifth Embodiment

A fifth embodiment of the present disclosure is described below with reference to the drawings. Note that, since the basic configuration of the present embodiment is similar to that in the first embodiment, a characteristic configuration is described below.

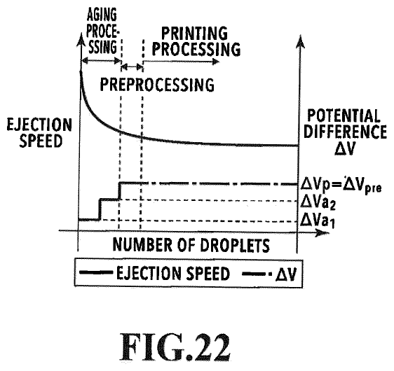

FIG. 22 is a diagram illustrating a change in the ejection speed in a case where the aging processing is executed.

FIG. 22 is a diagram illustrating a change in the ejection speed in a case where potential differences ΔVa₁, ΔVa₂ smaller than the potential difference during the printing (ΔVa₁<Va₂<ΔVp) are adopted during the aging processing, and the potential difference ΔVpre during the preprocessing performed before the printing and the potential difference ΔVp during the printing are the same (ΔVpre=ΔVp) for the potential difference between the potential of the electrode 121 of the upper portion protection layer of the heater and the potential of the opposing electrode 129.

It is necessary to be careful in a case where the potential difference ΔVa during the aging processing is changed to the potential difference ΔVp during the printing. That is, a rapid change in the potential difference causes a rapid change in the adhesion of the kogation to the upper portion protection layer of the heater. In this case, for example, the kogation adhered during the aging processing may be suddenly removed, or the adhesion of the kogation may become uneven. Thus, in a case where the kogation is removed during the ejection or the adhesion of the kogation becomes uneven, the ejection characteristics are changed, and in some cases, image unevenness and the like occur, and the printing quality is degraded.

Based on the above, in the present embodiment, before the printing processing, the preprocessing is performed with the potential difference equal to that during the printing processing (ΔVpre=ΔVp). Thus, it is possible to provide a technique that can further suppress the occurrence of the image unevenness and the like without changing the above-described ejection characteristics during the printing processing.

Additionally, optimum values of the potential difference that facilitates the aging and the potential difference that achieves the smallest accumulation of the kogation depend on a type of the ink. In the above-described embodiment, the potential differences ΔVa₁ and ΔVa₂ during the aging processing and the potential difference ΔVp during the printing are different for the potential difference between the potential of the electrode 121 of the upper portion protection layer of the heater and the potential of the opposing electrode 129 is described; however, as long as either one of the potential differences ΔVa₁ and ΔVa₂ facilitates the aging, it is preferable to set the other to the potential difference equal to ΔVpre or ΔVp and obtain a state of optimal adhesion of the kogation on the heater during the printing processing.

$$( Δ {Va}_{1} \neq Δ Vpre = Δ Vp = Δ {Va}_{2} ) , ( Δ {Va}_{1} = Δ Vpre = Δ Vp \neq Δ {Va}_{2} )$$

Additionally, although the aging processing is executed with two stages of potential differences, which are the potential differences ΔVa₁ and ΔVa₂ in the above-described embodiment, the stages may be increased to be three or more stages.

$$( Δ {Va}_{1} < Δ {Va}_{2} < Δ {Va}_{3} < Δ {Va}_{4} … < Δ Vpre = Δ Vp ) \\ ( Δ {Va}_{1} < Δ {Va}_{2} = Δ {Va}_{3} < Δ {Va}_{4} … < Δ Vpre = Δ Vp )$$

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156564, filed Sep. 10, 2024, No. 2025-113920 filed Jul. 4, 2025 which are hereby incorporated by reference herein in their entirety.

What is claimed is:

1. A liquid ejection apparatus, comprising:
an ejection unit mountable therein, including a heat generation resistor configured to generate energy to eject a liquid by generating heat by applying power, a first electrode provided to a protection unit configured to cover and protect the heat generation resistor, and a second electrode conductible with the first electrode via the liquid; and
a control unit configured to control a potential difference between the first electrode and the second electrode to a predetermined value by changing at least either one of potentials of the first electrode and the second electrode and control the mounted ejection unit, wherein
the control unit executes
aging processing to accumulate kogation on the first electrode by generating a first potential difference between the first electrode and the second electrode and performing ejection that does not contribute to printing on a printing medium from the ejection unit,
preprocessing to perform ejection that does not contribute to the printing on the printing medium from the ejection unit by generating a second potential difference, which is different from the first potential difference, after the aging processing, and
printing processing to eject the liquid from the ejection unit to the printing medium and perform printing by generating a third potential difference, which is different from the first potential difference and the second potential difference, between the first electrode and the second electrode after the preprocessing.

2. The liquid ejection apparatus according to claim 1, wherein
the first potential difference is smaller than the second potential difference.

3. The liquid ejection apparatus according to claim 1, wherein
the first potential difference is greater than the second potential difference.

4. The liquid ejection apparatus according to claim 1, wherein
the second potential difference is smaller than the third potential difference.

5. The liquid ejection apparatus according to claim 1, wherein
the second potential difference is greater than the third potential difference.

6. The liquid ejection apparatus according to claim 1, wherein
the first electrode is a negative pole and the second electrode is a positive pole.

7. The liquid ejection apparatus according to claim 1, wherein
the first electrode is a positive pole and the second electrode is a negative pole.

8. The liquid ejection apparatus according to claim 1, wherein
the first electrode and the second electrode are negative poles.

9. The liquid ejection apparatus according to claim 1, wherein
the first electrode and the second electrode are positive poles.

10. The liquid ejection apparatus according to claim 1, wherein
an absolute value of each of the first potential difference, the second potential difference, and the third potential difference is greater than O V and equal to or smaller than 2.5 V.

11. The liquid ejection apparatus according to claim 6, wherein
the ejection unit ejects the liquid including negatively charged particles.

12. The liquid ejection apparatus according to claim 7, wherein
the ejection unit ejects the liquid including positively charged particles.

13. The liquid ejection apparatus according to claim 1, wherein
between the preprocessing and the printing processing, the control unit further executes second preprocessing to perform ejection that does not contribute to the printing on the printing medium from the ejection unit by generating a fourth potential difference, which is different from the first potential difference, the second potential difference, and the third potential difference, between the first electrode and the second electrode.

14. A control method of a liquid ejection apparatus, the liquid ejection apparatus including
an ejection unit mountable therein, including a heat generation resistor configured to generate energy to eject a liquid by generating heat by applying power, a first electrode provided to a protection unit configured to cover and protect the heat generation resistor, and a second electrode conductible with the first electrode via the liquid, and
a control unit configured to control a potential difference between the first electrode and the second electrode to a predetermined value by changing at least either one of potentials of the first electrode and the second electrode and control the mounted ejection unit, the control method comprising:
performing aging processing to accumulate kogation on the first electrode by generating a first potential difference between the first electrode and the second electrode and performing ejection that does not contribute to printing on a printing medium from the ejection unit,
determining whether the kogation is adhered by the aging processing;
performing preprocessing to perform ejection that does not contribute to the printing on the printing medium from the ejection unit by generating a second potential difference, which is different from the first potential difference, after the aging processing;
determining whether the kogation is evenly adhered by the preprocessing; and
performing printing processing to eject the liquid from the ejection unit to the printing medium and perform printing by generating a third potential difference, which is different from the first potential difference and the second potential difference, between the first electrode and the second electrode after the preprocessing.

15. A liquid ejection apparatus, comprising:
an ejection unit mountable therein, including a heat generation resistor configured to generate energy to eject a liquid by generating heat by applying power, a first electrode provided to a protection unit configured to cover and protect the heat generation resistor, and a second electrode conductible with the first electrode via the liquid; and
a control unit configured to control a potential difference between the first electrode and the second electrode to a predetermined value by changing at least either one of potentials of the first electrode and the second electrode and control the mounted ejection unit, wherein
the control unit executes
aging processing to accumulate kogation on the first electrode by generating a first potential difference between the first electrode and the second electrode and performing ejection that does not contribute to printing on a printing medium from the ejection unit,
printing processing to eject the liquid from the ejection unit to the printing medium and perform printing by generating a second potential difference between the first electrode and the second electrode after the aging processing, and
preprocessing to perform ejection that does not contribute to the printing on the printing medium from the ejection unit by generating a third potential difference, which is the same as the second potential difference, between the first electrode and the second electrode before the printing processing.

16. The liquid ejection apparatus according to claim 15, wherein
the first potential difference is smaller than the third potential difference.

17. The liquid ejection apparatus according to claim 15, wherein
the first potential difference is greater than the third potential difference.

18. The liquid ejection apparatus according to claim 15, wherein
the first electrode is a negative pole, and the second electrode is a positive pole.

19. The liquid ejection apparatus according to claim 15, wherein
the first electrode is a positive pole, and the second electrode is a negative pole.

20. The liquid ejection apparatus according to claim 15, wherein
the first electrode and the second electrode are negative poles.

21. The liquid ejection apparatus according to claim 15, wherein
the first electrode and the second electrode are positive poles.

22. The liquid ejection apparatus according to claim 15, wherein
an absolute value of each of the first potential difference, the second potential difference, and the third potential difference is greater than O V and equal to or smaller than 2.5 V.

23. The liquid ejection apparatus according to claim 18, wherein
the ejection unit ejects the liquid including negatively charged particles.

24. The liquid ejection apparatus according to claim 19, wherein
the ejection unit ejects the liquid including positively charged particles.

25. The liquid ejection apparatus according to claim 15, wherein
between the aging processing and the printing processing, the control unit further executes second aging processing to perform ejection that does not contribute to the printing on the printing medium from the ejection unit by generating a fourth potential difference, which is different from the third potential difference, between the first electrode and the second electrode.

26. A control method of a liquid ejection apparatus, the liquid ejection apparatus including
an ejection unit mountable therein, including a heat generation resistor configured to generate energy to eject a liquid by generating heat by applying power, a first electrode provided to a protection unit configured to cover and protect the heat generation resistor, and a second electrode conductible with the first electrode via the liquid, and
a control unit configured to control a potential difference between the first electrode and the second electrode to a predetermined value by changing at least either one of potentials of the first electrode and the second electrode and control the mounted ejection unit, the control method comprising:
performing aging processing to accumulate kogation on the first electrode by generating a first potential difference between the first electrode and the second electrode and performing ejection that does not contribute to printing on a printing medium from the ejection unit,
determining whether the kogation is adhered by the aging processing;
performing printing processing to eject the liquid from the ejection unit to the printing medium and perform printing by generating a second potential difference between the first electrode and the second electrode after the aging processing;
performing preprocessing to perform ejection that does not contribute to the printing on the printing medium from the ejection unit by generating a third potential difference, which is the same as the second potential difference, between the first electrode and the second electrode before the printing processing; and
determining whether the kogation is evenly adhered by the preprocessing.
